(19) United States
(12) Patent Application Publication
(10) Pub. No.: US 2010/0320779 A1
(43) Pub. Date: Dec. 23, 2010

(54) PULLING KNOB, AND DOOR HAVING THE SAME

(76) Inventor: Dong Gil Kevin YOO, Seoul (KR)

Correspondence Address: Jae Y. Park, Kile, Park, Goekjian, Reed & McManus, PLLC, 1200 New Hampshire Ave. NW, Suite 570, Washington, DC, 20036, US

(21) Appl. No.: 12/840,586

(22) Filed: Jul. 21, 2010

Related U.S. Application Data
(63) Continuation-in-part of application No. PCT/KR2009/003351, filed on Jun. 23, 2009.

(51) Int. Cl. E05B 1/00

(52) U.S. Cl. 292/336.3

(57) ABSTRACT

Disclosed is a pulling knob and a door having the same. A pulling knob for a door, which is mounted to the door rotatable to open and close a predetermined space, the pulling knob comprising at least one of a first inclined member inclined in a direction to get near to the door in a downward direction along a direction approximately parallel with a central axis on which the door pivots and a second inclined member inclined in a direction to get away from the door as going in the downward direction along the direction approximately parallel with the central axis on which the door pivots.

### CROSS-REFERENCE TO RELATED APPLICATIONS

This application is a continuation-in-part application of PCT/KR2009/003351 filed on Jun. 23, 2009, the disclosure of which is incorporated herein by reference.

### TECHNICAL FIELD

The present invention relates to a knob of a hinged door, and a hinged door having the same. In more detail, the present invention relates to a pulling knob configured to regulate a hinged door to be opened in one direction, and a door having the same.

Generally, a door is installed to a frame of an exit at its one edge by a hinge so as to be opened by pushing or pulling a knob. After being opened, the hinged door is automatically closed due to a restoring force of a predetermined elastic device coupled to the hinge.

The hinged door is pivoted on the hinge when being opened or closed. Thus, if users located in and out of the exit pull or push the knobs in opposite directions together, the hinged door is substantially not pivoted, so the hinged door may not be opened.

In fact, at a hinged door used as a bi-direction door in public facilities such as government offices and banks, the above problem occurs frequently since a lot of persons pass through the hinged door.

Some hinged doors have notices attached at interior and exterior door surfaces thereof so as to guide passengers to push or pull the hinged door, but passengers seldom check the notice while opening or closing the hinged door due to busy and congested circumstances.

As an alternative, a stopper may be installed to prohibit a pivotal movement of the hinged door in one direction such that the hinged door may be opened only in one direction, namely inwards or outwards. However, if such a stopper is installed at the hinged door, when a user pushes a knob of the hinged door in a prohibited direction, the door keeps its fixed state against the user's will, so the user may be confused or feel inconvenience. Even in a serious case, the force applied from the user to the knob may be inversely influenced back to the user to give an excessive stress to the joint or muscle of the user, which may hurt the user.

### DISCLOSURE OF INVENTION

Technical Problem

The present invention is designed to solve the problems of the prior art, and therefore it is an object of the present invention to provide a pushing knob of a hinged door, which have ergonomic structures for regulating the hinged door to be opened in one direction and also allowing a user to recognize an opening direction of the hinged door by intuition and give a force properly. The present invention is also directed to providing a door having the same.

Technical Solution

The foregoing and/or other aspects can be achieved by providing a pulling knob for a door, which is mounted to the door rotatable to open and close a predetermined space, the pulling knob comprising at least one of a first inclined member inclined in a direction to get near to the door in a downward direction along a direction approximately parallel with a central axis on which the door pivots and a second inclined member inclined in a direction to get away from the door as going in the downward direction along the direction approximately parallel with the central axis on which the door pivots.

The first inclined member and the second inclined member may be connected to each other.

An end part of the second inclined member may be spaced apart from the door.

The second inclined member may comprise an exposure surface approximately flat and exposed frontward to show an advertisement.

The pulling knob for a door may further comprise a first coupling member which couples a connecting portion between the first inclined member and the second inclined member to the door body.

A first end of the first inclined member and a first end of the second inclined member are connected to each other, the pulling knob further comprising a first coupling member which couples a second end of the first inclined member with the door; and a second coupling member which couples a second end of the second inclined member with the door.

An end part of the first or second inclined member may be spaced apart from the door.

The pulling knob for a door may further comprise one of a first coupling member coupling the first inclined member with the door and a second coupling member coupling the second inclined member with the door.

At least one of the first and second inclined members may comprise a rod or plate structure.

At least one of the first and second inclined members may comprise guide grooves for placing fingers of a human body therein.

The pulling knob for a door may further comprise an opposite member facing the door and one of the first inclined member and the second inclined member.

Another aspect of the present invention can be achieved by providing a door pivoting on a predetermined central axis to be closed and opened, the door comprising: a door body; and a pulling knob comprising at least one of a first inclined member inclined in a direction to get near to the door as going in a downward direction along a direction approximately parallel with the central axis on which the door pivots and a second inclined member inclined in a direction to get away from the door as going in the downward direction along the direction approximately parallel with the central axis on which the door pivots.

The first inclined member and the second inclined member may be connected to each other.

The second inclined member may comprise an exposure surface approximately flat and exposed frontward to show an advertisement.

A first end of the first inclined member and a first end of the second inclined member may be connected to each other, the pulling knob further comprising a first coupling member which couples a second end of the first inclined member with the door; and a second coupling member which couples a second end of the second inclined member with the door.

The pulling knob may further comprise an opposite member facing the door and one of the first inclined member and the second inclined member.

The door may further comprise a pushing knob comprising a base surface mounted to a door surface of the door, and a pad surface formed at an opposite side of the base surface and inclined to gradually get away from the surface of the door body as going in a downward direction.

The pulling knob may comprise at least one of a first coupling member coupling the first inclined member with the door body and a second coupling member coupling the second inclined member with the door body, and the first coupling member or the second coupling member may be coupled to the pulsing knob with the door body therebetween.

The door may further comprise a depressed portion corresponding to a hand shape of a human body in the surface of the pushing knob.

The depressed portion may have a depth gradually decreased as going in a downward direction of the door body.

### ADVANTAGEOUS EFFECTS

The knobs for a hinged door according to the present invention has an ergonomic structure such that a user may push or pull the knobs in a natural and convenient way, so a user may recognize an opening direction of the hinged door by intuition and operate the hinged door properly.

Thus, it may solve the problem that users in and out of the exit pull or push the hinged door in opposite directions at the same time. In this way, the knobs of the present invention may give convenience to users while preventing any accident.

### BRIEF DESCRIPTION OF DRAWINGS

Other objects and aspects of the present invention will become apparent from the following description of embodiments with reference to the accompanying drawing in which:

FIG. 1 is a perspective view showing a pulling knob according to a first exemplary embodiment of the present invention;

FIG. 2 is a side view showing a hinged door provided with the pulling knob of FIG. 1;

FIG. 3 is a perspective view showing an appearance of a pushing pad provided according to an exemplary embodiment of the present invention;

FIG. 4 is a side view showing a hinged door provided with a pulling knob and a pushing knob according to an exemplary embodiment of the present invention;

FIG. 5 is a side view illustrating how the hinged door according to an exemplary embodiment is operated;

FIGS. 6A to 6C are side, front and plan views of a pulling knob according to a second exemplary embodiment of the present invention;

FIGS. 7A and 7B are front and side views of a pulling knob according to a third exemplary embodiment of the present invention;

FIGS. 8A and 8B are front and side views of a pulling knob according to a fourth exemplary embodiment of the present invention;

FIG. 9 is a side view of a pulling knob according to a fifth exemplary embodiment of the present invention;

FIG. 10 is a side view of a pulling knob according to a sixth exemplary embodiment of the present invention;

FIG. 11 is a side view of a pulling knob according to a seventh exemplary embodiment of the present invention;

FIGS. 12A and 12B are side and front views of a pulling knob according to an eighth exemplary embodiment of the present invention;

FIG. 13 is a side view of a pulling knob according to a ninth exemplary embodiment of the present invention;

FIG. 14 is a side view of a pulling knob according to a tenth exemplary embodiment of the present invention;

FIG. 15 is a perspective view of a pulling knob according to an eleventh exemplary embodiment of the present invention; and

FIG. 16 is a schematic side view of a door having the pulling knob of FIG. 15.

### REFERENCE NUMERALS OF ESSENTIAL PARTS IN THE DRAWINGS

100: upper post (first coupling member) 101: lower post (second coupling member)

102a: first grip portion (first inclined member) 102b: second grip portion (second inclined member)

103: buffer pad 105, 105′: guide groove

200: pushing knob 201a: base surface

201b: pad surface 202: depressed portion

300, 400, 500, 600, 700, 800, 900, 1000, 1100, 1200: pulling knob

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

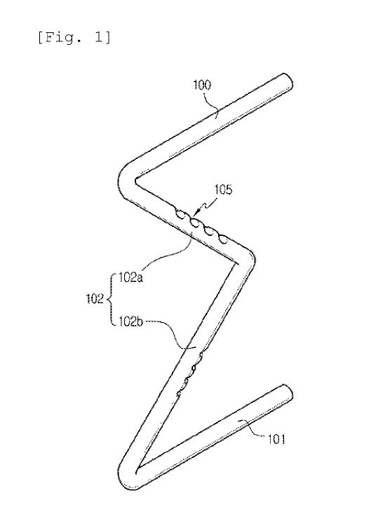

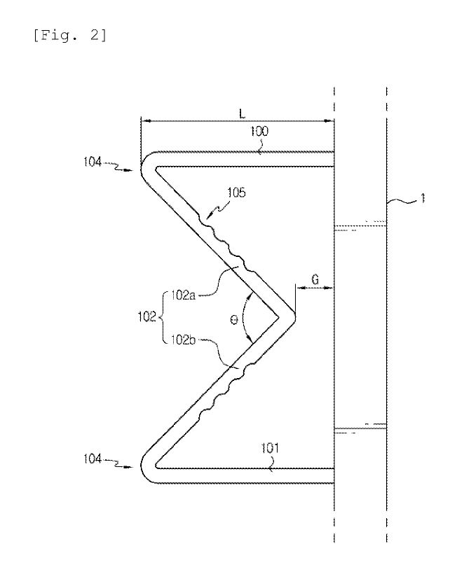

FIGS. 1 and 2 show a pulling knob and a hinged door having the same according to a first exemplary embodiment of the present invention.

Referring to FIGS. 1 and 2, a pulling knob of the present invention includes an upper post 100 and a lower post 101, mounted to one side of a door body 1, and a grip 102 provided between the upper post 100 and the lower post 101.

The upper post 100 and the lower post 101 are respectively mounted to a door surface of the door body 1 at their one ends to play a role of supporting the body of the pulling knob. The upper post 100 and the lower post 101 preferably have a rod structure perpendicular to the door surface, but they may also have a ribbon structure, not limited thereto. Also, the upper post 100 and the lower post 101 preferably have a linear shape, but they may also have a curved shape, not limited thereto.

Though not shown in the figure, a common bolt-nut structure may be adopted to mount one ends of the upper post 100 and the lower post 101 to the door body 1, and various kinds of coupling means may also be used. For better coupling, a predetermined flange or bracket may be additionally fixed to ends of the upper post 100 and the lower post 101, mounted to the door body 1.

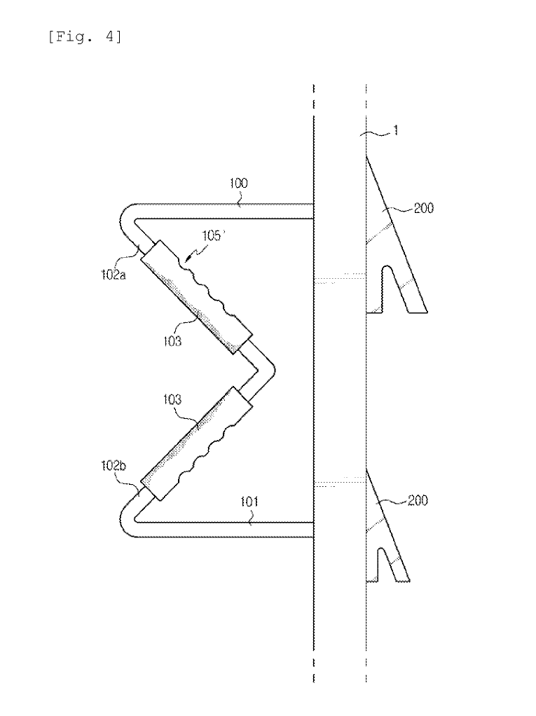

The grip 102 includes a first grip portion 102a and a second grip portion 102b, respectively extending from the other ends of the upper post 100 and the lower post 101. Similarly to the upper post 100 and the lower post 101, the grip 102 preferably has a rod structure or a ribbon structure. Also preferably, the grip 102 is integrally formed with the upper post 100 and the lower post 101 by means of injection molding or bending. In order to protect the hand of a user who grasps the grip, a buffer pad 103 (see FIG. 4) made of sponge or decorating sheet is preferably provided to surround some portions of the upper post 100 and the lower post 101.

The first grip portion 102a and the second grip portion 102b extends toward the door surface while being tilted, and they are connected each other. Since the first grip portion 102a and the second grip portion 102b are tilted toward the door surface, the wrist of a user is slightly bent upwards or downwards while the hand of the user grasps the corresponding grip, so the pulling motion may be made naturally in aspect of the structure of a human body. However, in such a state, the pushing motion is unnatural and does not give a sufficient force toward the door. Meanwhile, since the upper and lower posts 100, 101 extends in opposite directions of the first and second grip portions 102a, 102b, a protrusion 104 sharply protruding substantially toward a user is formed at a portion where the upper or lower post 100, 101 is connected with the grip 102. The protrusion 104 naturally arouses unwelcome attention against pushing motion, thereby inducing a user to pull the pulling knob.

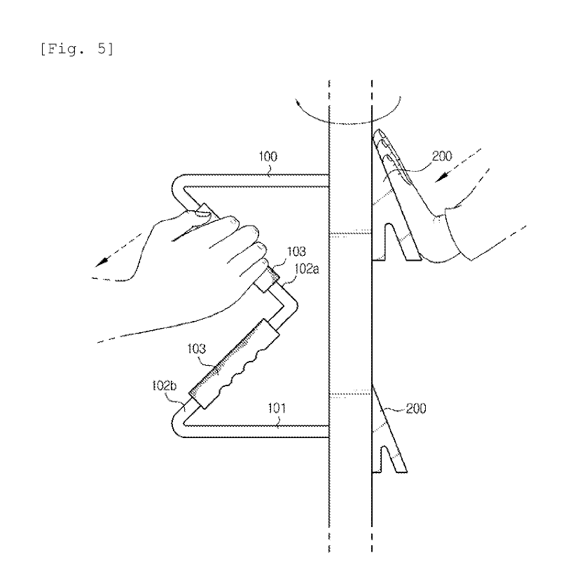

As shown in FIG. 5, the first grip portion 102a is inclined toward the door as going downward along a direction approximately parallel with an axial direction of a central axis on which the door pivots, which may be called a first inclined member 102a. Also, as shown in FIG. 5, the second grip portion 102b is inclined away from the door as going downward along a direction approximately parallel with the axial direction of the central axis on which the door pivots, which may be called a second inclined member 102a.

The first inclined member 102a is inclined to get near to the door body 1 as going in a downward direction of the door body 1, and the second inclined member 102b is inclined to become spaced apart from the door body 1 as going in the downward direction of the door body 1.

Also, the upper post 100 and the lower post 101 may be called a first coupling member 100 and a second coupling member 101 in that they are used in coupling the first inclined member 102a and the second inclined member 102b to the door, respectively. In more detail, first ends of the first inclined member 102a and the second inclined member 102b are coupled to each other, and a second end of the first inclined member 102a is coupled to a first end of the first coupling member 100. A second end of the second inclined member 102b is coupled to a first end of the second coupling member 101.

Thus, when manipulating the pulling knob, a user takes an action of pulling the pulling knob toward his/her body by intuition while grasping the first or second grip portion 102a, 102b. In order to induce such a user action more efficiently, the upper and lower posts 100, 101 are preferably designed to have a length L of 20 cm or less, and an angle (θ) between the first and second grip portions 102a, 102b is preferably designed as 90° to 120°. These numerical ranges have threshold meanings in aspect of ergonomics since the titled structure of the first and second grip portions 102a, 102b and their protrusions are remarkable in the above ranges, and the wrist of a user is naturally bent in the above ranges not to exert excessive force when the user grasps and pulls the grip 102.

Here, the ranges of the angle (θ) between the first and second grip portions 102a and 102b are nothing but an example, and may be altered variously.

A portion where the first and second grip portions 102a, 102b are connected with each other preferably has a gap G of 4 cm or more from the door surface so as to prevent any accident at that portion such as jamming of a finger.

Also, guide grooves 105 are preferably formed in the first and second grip portions 102a, 102b such that fingers of a human body are placed therein. The guide grooves 105 induce a user to grasp and pull the first and second grip portions 102a, 102b by intuition, and also the guide grooves 105 help fingers of a user to be closely adhered to the first and second grip portions 102a, 102b in a convenient way when the user grasps the grip. In case the buffer pad 103 is provided to the first and second grip portions 102a, 102b, guide grooves 105′ are preferably formed in the buffer pad 103.

Here, the guide grooves 105 may be omitted in some cases.

Also, the guide grooves 105 may be replaced by projections. As necessary, the first and second grip portions 102a, 102b may undergo surface treatment to have a rough surface instead of having the guide grooves 105.

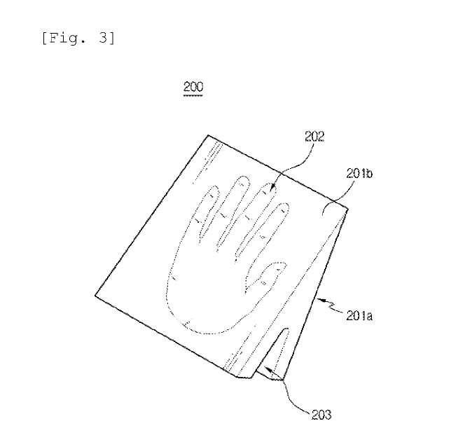

The hinged door of the present invention may be further provided with a pushing knob 200 as shown in FIG. 3. The pushing knob 200 is used for a user to push and open the hinged door. The pushing knob 200 includes a pad body, which has a base surface 201a substantially processed flat so as to be mounted to the hinged door, and a pad surface 201b prepared at an opposite side of the base surface 201a and having a tilted structure in one direction.

As shown in FIG. 4, the pushing knob 200 is configured such that the base surface 201a is mounted to the other side of the door body 1, and the pad surface 201b is inclined so as to be gradually spaced apart from the surface of the door body 1 in a downward direction of the door body 1. In aspect of the structure of a human body, a lower portion of the palm is located closer to the human body than an upper portion of the palm when a user pushes the hinged door. Thus, the inclined structure of the pad surface of the pushing knob 200, inclined to be closer to the body of a user in a downward direction of the door body 1, is well matching with the human body.

When manipulating the pushing knob, a user places his/her palm on the surface of the pushing knob 200 by intuition and then takes an action for applying a force toward the door body 1 and thus pushing the hinged door. To allow a user to make such an action easily, the pushing knob 200 should be installed at a suitable height in consideration of the height of a user. In this point of view, it is preferred that two pushing knobs 200 are installed in upper and lower portions of the door body 1 for adults and children, as shown in FIG. 5.

A depressed portion 202 corresponding to a hand shape is preferably formed in the surface of the pushing knob 200 so as to induce a pushing action of the user. The depressed portion 202 of the pushing knob 200 attracts user's eyes. Thus, if an advertisement (not shown) is provided to the depressed portion 202, an effective advertising function may be obtained. Here, the depressed portion 202 preferably has a depth gradually decreased in a downward direction of the door body 1 such that water or im-purities may be easily discharged downwards.

Additionally, a concave portion 203 defining a predetermined cavity is prepared at a lower end of the pad body of the pushing knob 200 such that a user may put his/her fingers therein. The concave portion 203 allows a user to put fingers therein and then temporarily pull the pushing knob 200, when required.

Meanwhile, as shown in FIG. 4, the pushing knob 200 and the upper post 100 of the pulling knob may be fastened to each other by a fastening unit B with the door body 1 therebetween. The fastening unit B may be fastened in a direction from the pushing knob 200 toward the upper post 100. The upper post 100 may be internally formed with thread to mate with the fastening unit B such that the fastening unit B can be inserted in the upper post 100. Like the upper post 100, the lower post 101 of the pulling knob may also be fastened to the pushing knob 200 by the fastening unit B with the door body 1 therebetween.

FIG. 5 illustrates an operating state of the hinged door according to the preferred embodiment of the present invention. As shown in FIG. 5, the hinged door according to the preferred embodiment of the present invention is configured such that the pulling knob is mounted to one side of the door body 1 and the pushing knob 200 is mounted to the other side of the door body 1. In FIG. 5, the door body 1 is regulated to be opened only in a left direction. Thus, a user located in a left side based on the door body 1 may recognize by intuition from the tilted structure of the grip 102 and the protrusion 104 formed at the pulling knob that he/she should pull the pulling knob, so the user then grasps any one of the first and second grip portions 102a, 102b and takes a pulling action to open the hinged door.

Meanwhile, a user located in a right side based on the door body 1 may recognize by intuition from the depressed portion 202 of a hand shape and the tilted structure of the pushing knob 200 tilted toward the user's body in a downward direction that he/she should push the pushing knob 200, so the user then places the palm on the depressed portion 202 of the pushing knob 200 and applies a force toward the door body 1 to take a pushing action, thereby opening the hinged door.

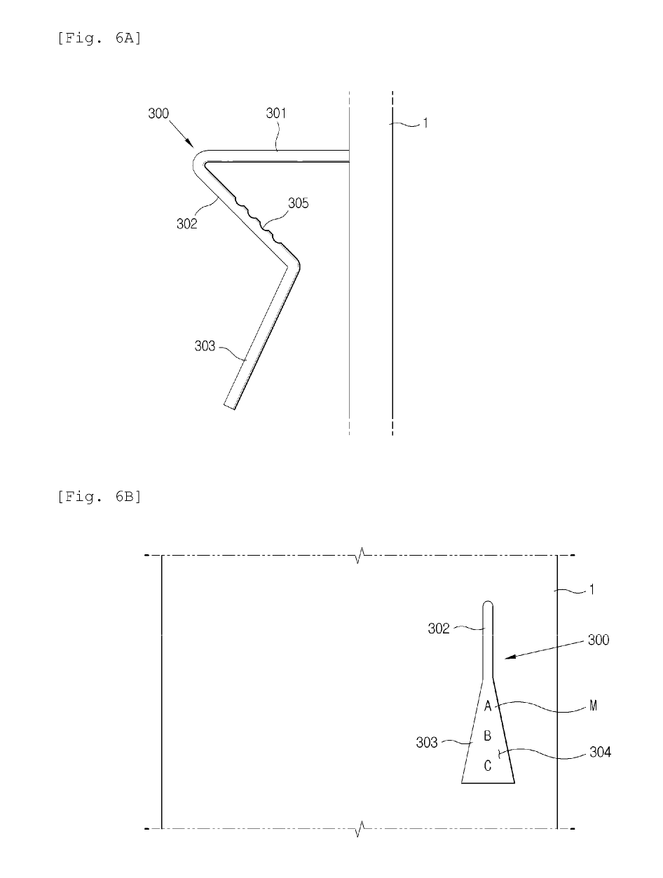

Referring to FIGS. 6A to 6C, a pulling knob 300 according to a second exemplary embodiment of the present invention includes a first coupling member 301 mounted to one side of the door body 1, a first inclined member 302 inclined down from the first coupling member 301 toward the door body 1; and a second inclined member 303 inclined down from the first inclined member 302 in an outward direction getting away from the door body 1.

The first coupling member 301 may be fastened to the door body 1 by a fastening unit or glue. Alternatively, the door body 1 may be formed with a hooking groove (not shown) and the first coupling member 301 may be formed with a hooking projection (not shown), so that the first coupling member 301 can be hooked to the door body 1. For reference, various known coupling methods can be employed besides the foregoing coupling method.

The first inclined member 302 may be formed with a guide groove 305 along a lengthwise direction of the first inclined member 302 so that fingers can be readily placed therein. Here, a plurality of (e.g., four) guide grooves 305 may be provided such that four fingers except a thumb can be individually placed therein. Alternatively, the guide grooves 305 may be provided as a single elongated groove to place the plurality of fingers therein.

The second inclined member 303 may include an exposure surface 304 exposed in a frontward direction as shown in FIG. 6B.

The exposure surface 304 shows an advertisement configured with a predetermined letter, a predetermined picture or combination thereof. In some cases, predetermined decorations may be mounted to the exposure surface 304. As necessary, a predetermined display panel (not shown) for advertisement may be attached to the exposure surface 304.

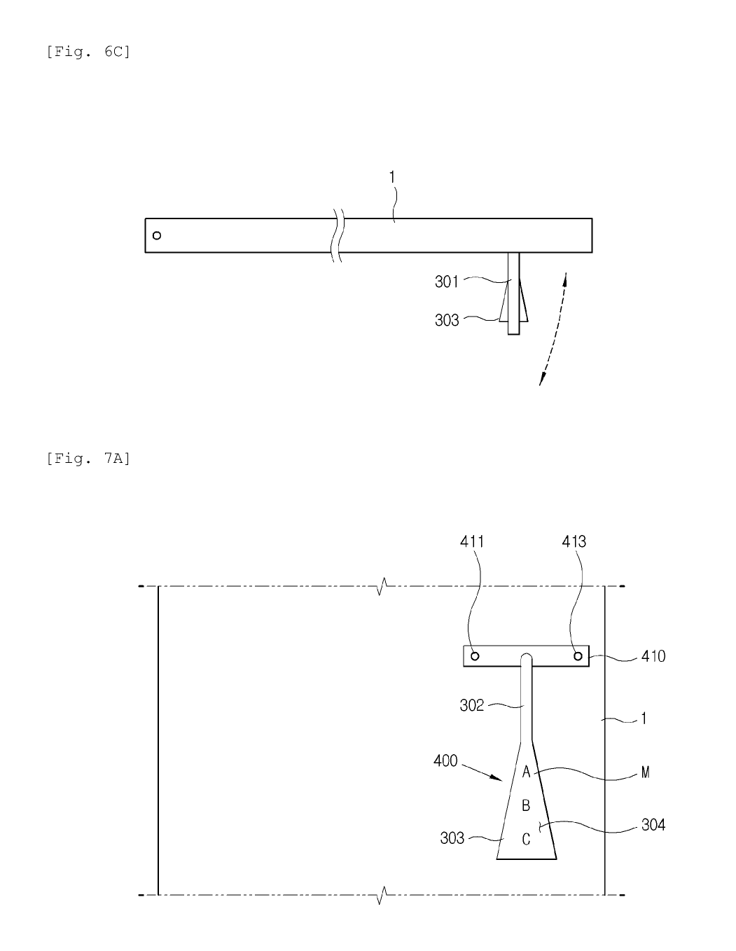

Referring to FIGS. 7A and 7B, a pulling knob 400 according to a third exemplary embodiment of the present invention includes the first coupling member 301, the first inclined member 302, the second inclined member 303, and a bracket 410 placed between the first coupling member 301 and the door body 10.

The pulling knob 400 of the third exemplary embodiment is the same as that of the second exemplary embodiment except that the bracket 405 is additionally provided.

The bracket 410 may be a plate that is extended to opposite sides with the first coupling member 301 therebetween. The bracket 410 may include fastening holes 411 and 413 into which fastening units are inserted at opposite sides with the first coupling member 301 therebetween.

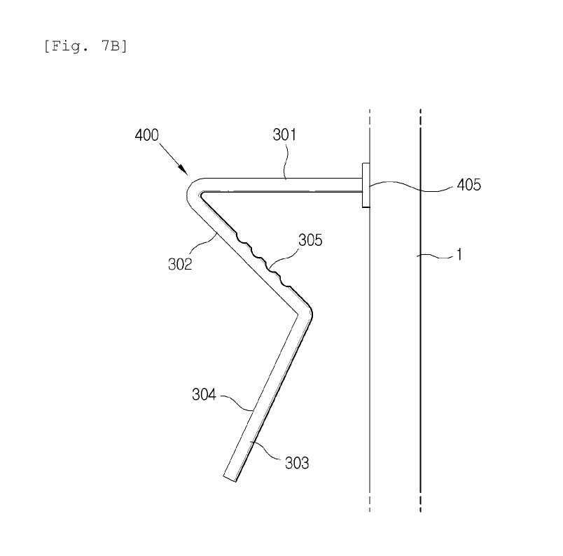

Referring to FIGS. 8A and 8B, a pulling knob 500 according to a fourth exemplary embodiment of the present invention includes a first inclined member 502 inclined to get near to the door body 1 as going in a downward direction D along the downward direction D of the door body 1; and a first coupling member 501 coupling the first inclined member 502 to the door body 1.

The first coupling member 501 may perpendicularly stand on the door body 1, and have a first end coupled to the door body 1 and a second end coupled to a first end 502b of the first inclined member 502.

The first inclined member 502 is inclined such that its second end 502a is closer to the door body 1 than the first end 502b as going from the first end 502b to the second end 502a.

The first inclined member 502 may be formed with a guide groove 502 such that fingers can be placed therein.

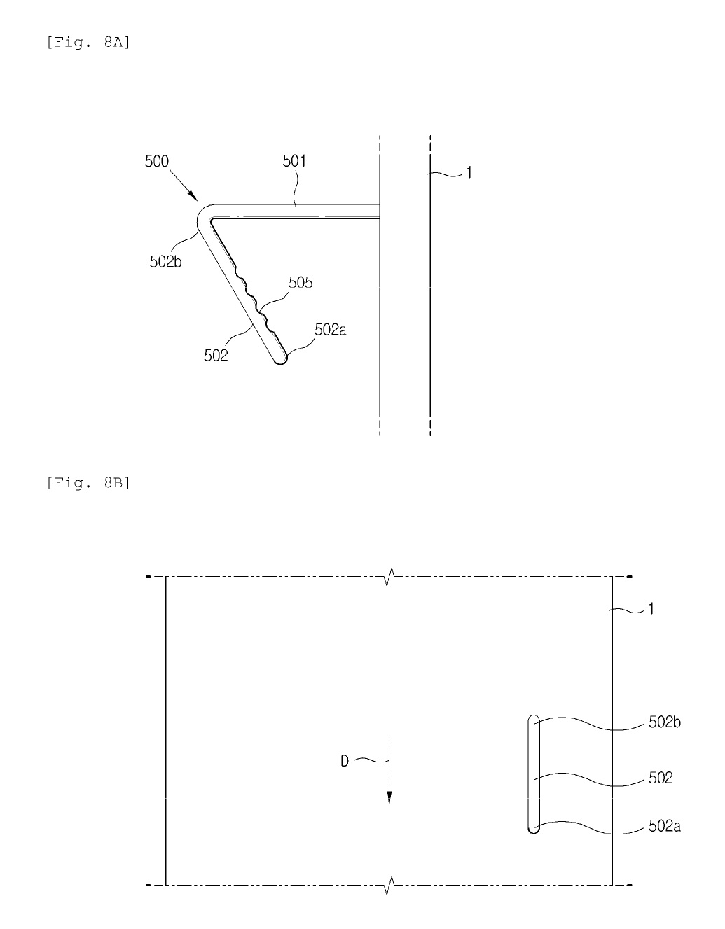

Referring to FIG. 9, a pulling knob 600 according to a fifth exemplary embodiment of the present invention includes a second inclined member 603 inclined getting away from the door body 1 as going in a downward direction D along the downward direction D of the door body 1; and a second coupling member 607 coupling the second inclined member 603 to the door body 1.

Here, the downward direction D refers to a gravitational direction approximately parallel with the central axis on which the door body 1 pivots.

The second inclined member 603 is inclined such that its first end 603b is closer to the door body 1 than its second end 603a.

The second inclined member 603 includes a guide groove 605 formed at a side facing the door body 1 such that fingers can be placed therein.

FIG. 9 shows that the second end 603a of the second inclined member 603 is spaced apart from the door body 1, but not limited thereto. Alternatively, the second end 603a may be extended and coupled to the door body 1.

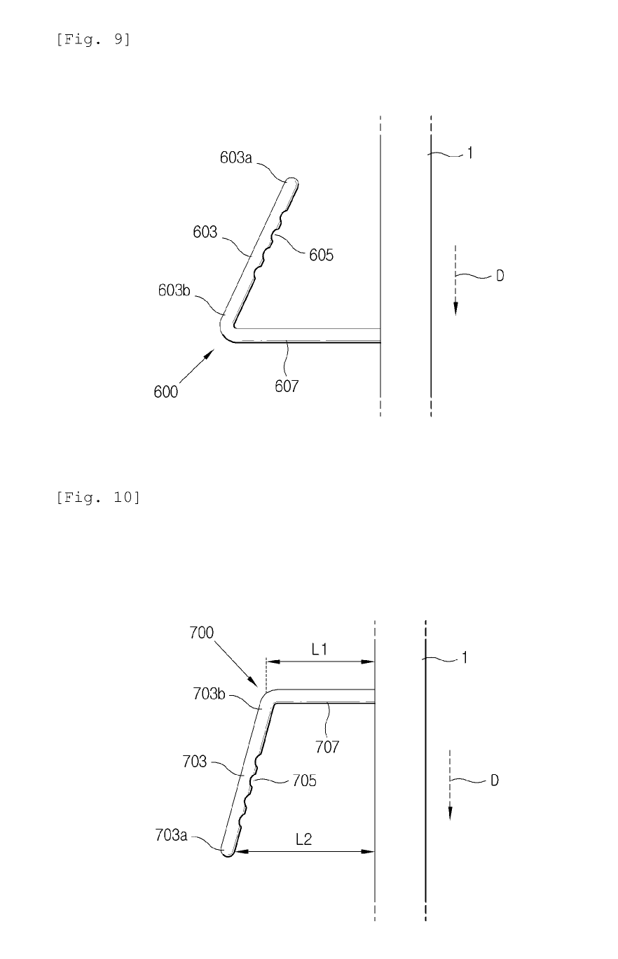

Referring to FIG. 10, a pulling knob 700 according to a sixth exemplary embodiment of the present invention includes a second inclined member 703 inclined getting away from the door body 1 as going in a downward direction D along the downward direction D of the door body 1; and a second coupling member 707 coupling the second inclined member 703 to the door body 1.

A length L1 from a first end 703b of the second inclined member 703 to the door body 1 is shorter than a length L2 from a second end 703a of the second inclined member 703 to the door body 1.

The second coupling member 707 includes a first end coupled to the first end 703b of the second inclined member 703, and a second end coupled to the door body 1.

The second inclined member 703 may be formed with a guide groove 705 such that fingers can be placed therein.

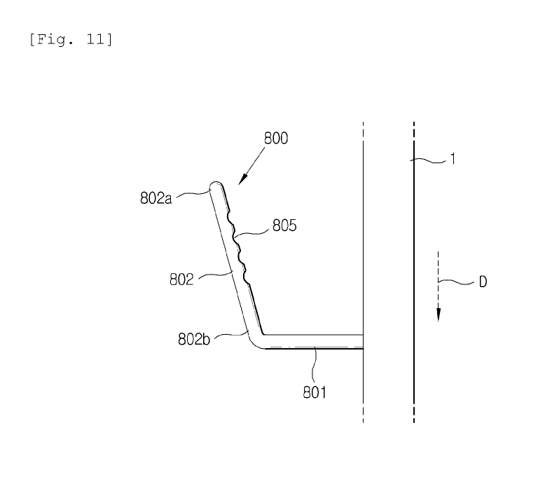

Referring to FIG. 11, a pulling knob 800 according to a seventh exemplary embodiment of the present invention includes a first inclined member 802 inclined to get near to the door body 1 as going in a downward direction D along the downward direction d of the door body 1; and a first coupling member 801 coupling the first inclined member 802 to the door body 1.

The first inclined member 802 is disposed such that its second end 802b is closer to the door body 1 than its first end 802a.

The first coupling member 801 includes a first end coupled to the second end 802b of the first inclined member 802, and a second end coupled to the door body 1.

The first inclined member 802 may be formed with a guide groove 805 such that fingers can be placed therein.

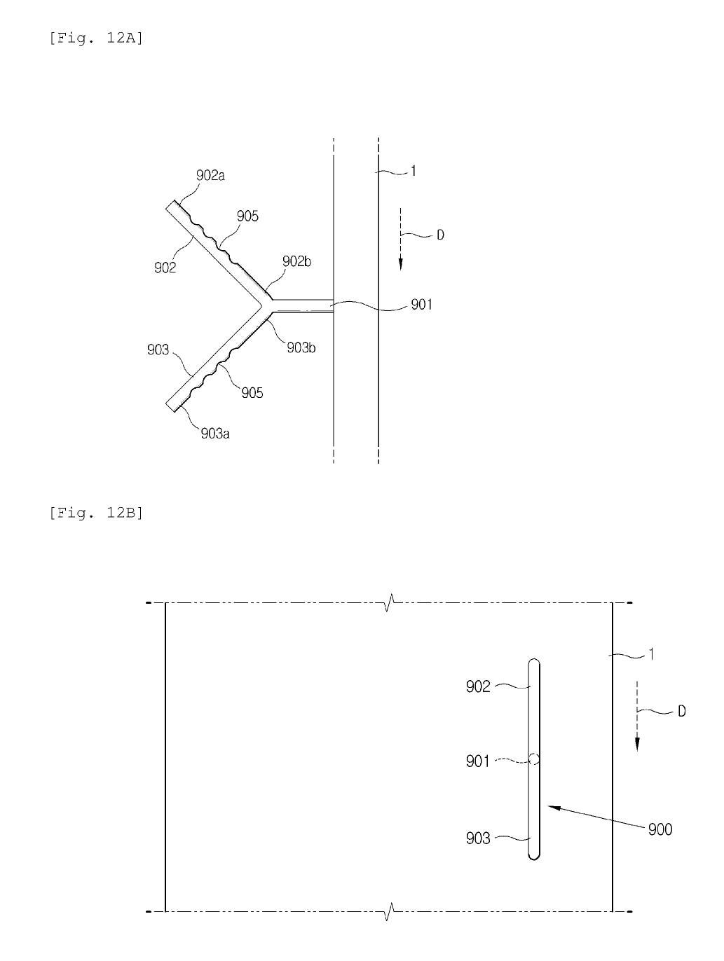

Referring to FIGS. 12A and 12B, a pulling knob 900 according to an eighth exemplary embodiment of the present invention includes a first inclined member 902 inclined to get near to the door body 1 as going in a downward direction D along the downward direction D of the door body 1; a second inclined member 903 inclined to get away from the door body 1 as going in the downward direction along the downward direction of the door body 1; and a coupling member 901 coupling the first inclined member 902 and the second coupling member 903 to the door body 1.

Here, the coupling member 901 couples a connecting portion between the first inclined member 902 and the second inclined member 903 to the door body 1.

The first inclined member 902 is disposed such that its second end 902b is closer to the door body 1 than its first end 902a.

The second inclined member 903 is disposed such that its first end 903a is more distant from the door body 1 than its second end 903b.

The second end 902b of the first inclined member 902, the second end 903b of the second inclined member 903, and the first end of the coupling member 901 are coupled to one another, and the second end of the coupling member 901 is coupled to the door body 1.

The first inclined member 902 and the second inclined member 903 may be respectively formed with guide grooves 905 and 906 such that fingers can be placed therein.

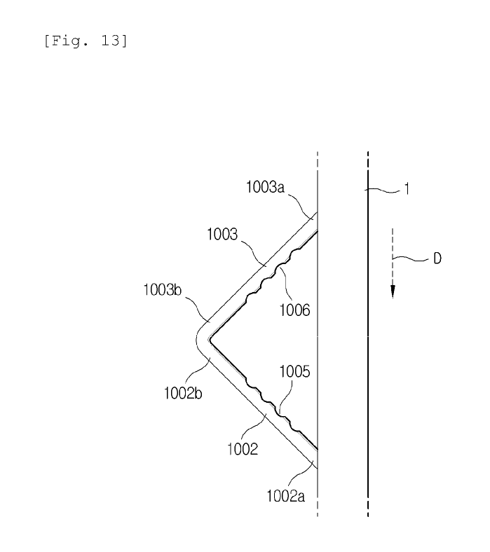

Referring to FIGS. 13, a pulling knob 1000 according to a ninth exemplary embodiment of the present invention includes a first inclined member 1002 inclined to get near to the door body 1 as going in a downward direction D along the downward direction D of the door body 1; and a second inclined member 1003 inclined to get away from the door body 1 as going in a downward direction D along the downward direction D of the door body 1.

A first end 1002b of the first inclined member 1002 is coupled to a first end 1003b of the second inclined member 1003, and a second end 1002a of the first inclined member 1002 is coupled to the door body 1.

A second end 1003a of the second inclined member 1003 is also coupled to the door body 1.

In some cases, one of the second ends 1002a and 1003a of the first and second inclined members 1002 and 1003 may be spaced apart from the door body 1 without being coupled to the door body 1.

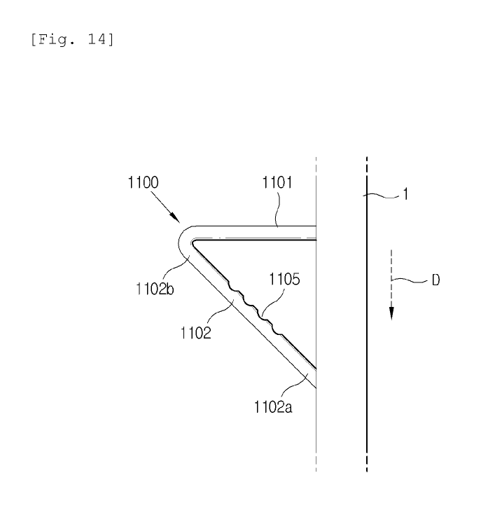

Referring to FIG. 14, a pulling knob 1100 according to a tenth exemplary embodiment of the present invention includes a first inclined member 1102 inclined to get near to the door body as going in a downward direction D along the downward direction D of the door body 1; and a first coupling member 1101 coupling the first inclined member 1102 to the door body 1.

The first inclined member 1102 is disposed such that its first end 1102a is closer to the door body 1 than its second end 1102b.

Here, the first end 1102a may be coupled to the door body 1.

A first end of the first coupling member 1101 is coupled to a second end 1102b of the first inclined member 802, and a second end of the first coupling member 1101 is coupled to the door body 1.

The first inclined member 1101 is formed with a guide groove 1105 such that fingers can be placed therein.

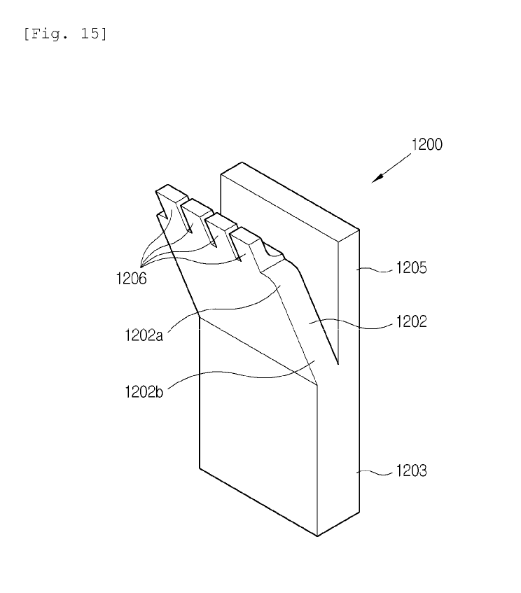

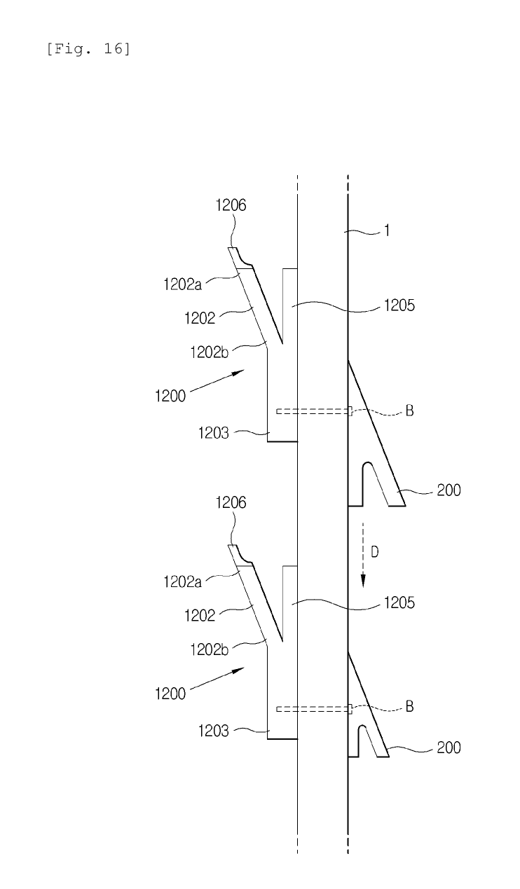

Referring to FIGS. 15 and 16, a pulling knob 1200 according to an eleventh exemplary embodiment of the present invention includes a first inclined member 1202 inclined to get near to the door body 1 as going in a downward direction along the downward direction D of the door body 1; and a first coupling member 1203 coupling the first inclined member 1202 to the door body 1.

The first inclined member 1202 is disposed such that its first end 1202b is closer to the door body 1 than its second end 1202a.

In some cases, the first coupling member 1203 may not be provided. In this case, the first inclined member 1202 may be directly coupled to the door body 1.

Also, the pulling knob 1200 may further include an opposite member 1205 extended from the first coupling member 1203 toward the first inclined member 1202 and facing the first inclined member 1202. Here, the opposite member 1205 may be provided to face the door body 1.

Further, the pulling knob 1200 may further include a pulling part 1206. The pulling part 1206 may be branched and protruded from the pulling knob 1200 so that a user can pull the pulling knob 1200 with four fingers except a thumb. Here, the pulling parts 1206 are shaped such that end parts of the four fingers can be placed therein, but not limited thereto. Alternatively, the pulling part may be protruded as a single body without branching. Besides, the shape of the pulling part may be changed variously. In some cases, the pulling part 1206 may not be provided. In this case, the pulling knob 1200 may be pulled by gripping the opened end 1202a of the first inclined member 1202.

As shown in FIG. 16, the pulling knob 1200 may be coupled to the foregoing pushing knob 200 with the door body 1 therebetween. The pushing knob 200 and the pulling knob 1200 may be coupled by a fastening unit B.

As shown in FIG. 16, a pair of the pulling knob 1200 and the pushing knob 200 may be provided in upper and lower sides to be opposite to each other with respect to the door body 1. As necessary, they may be provided in only the upper or lower side, or only the pulling knob 1200 may be provided instead of the pushing knob 200.

The first inclined member in this embodiment is shaped like a plate, while the first inclined members of the foregoing other embodiments are shaped like a rod. Besides, the first inclined member may have various shapes.

As described above, the pulling knob 100, 300, 400, 500, 600, 700, 800, 900, 1000, 1100, 1200 according to the foregoing embodiments may be provided as a single body. As necessary, the foregoing pulling knob may be formed by respectively manufacturing the first inclined member and/or the second inclined member and/or the first coupling member and/or the second coupling member as individual components and assembling them by fastening units, welding, glue or the like well-known coupling methods. The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A pulling knob for a door, which is mounted to the door rotatable to open and close a predetermined space, the pulling knob comprising at least one of a first inclined member inclined in a direction to get near to the door as going in a downward direction along a direction approximately parallel with a central axis on which the door pivots and a second inclined member inclined in a direction to get away from the door as going in the downward direction along the direction approximately parallel with the central axis on which the door pivots.

2. The pulling knob for a door according to claim 1, wherein the first inclined member and the second inclined member are connected to each other.

3. The pulling knob for a door according to claim 2, wherein an end part of the second inclined member is spaced apart from the door.

4. The pulling knob for a door according to claim 2, wherein the second inclined member comprises an exposure surface approximately flat and exposed frontward to show an advertisement.

5. The pulling knob for a door according to claim 2, further comprising a first coupling member which couples a connecting portion between the first inclined member and the second inclined member to the door body.

6. The pulling knob for a door according to claim 2, wherein a first end of the first inclined member and a first end of the second inclined member are connected to each other,
Wherein the pulling knob further comprises a first coupling member which couples a second end of the first inclined member with the door; and a second coupling member which couples a second end of the second inclined member with the door.

7. The pulling knob for a door according to claim 1, wherein an end part of the first or second inclined member is spaced apart from the door.

8. The pulling knob for a door according to claim 1, further comprising one of a first coupling member coupling the first inclined member with the door and a second coupling member coupling the second inclined member with the door.

9. The pulling knob for a door according to claim 1, wherein at least one of the first and second inclined members comprises a rod or plate structure.

10. The pulling knob for a hinged door according to claim 1, wherein at least one of the first and second inclined members comprises a guide groove for placing fingers of a human body therein.

11. The pulling knob for a door according to claim 1, further comprising an opposite member facing the door and one of the first inclined member and the second inclined member.

12. A door pivoting on a predetermined central axis to be closed and opened, the door comprising:
a door body; and
a pulling knob comprising at least one of a first inclined member inclined in a direction to get near to the door as going in a downward direction along a direction approximately parallel with the central axis on which the door pivots and a second inclined member inclined in a direction to get away from the door as going in the downward direction along the direction approximately parallel with the central axis on which the door pivots.

13. The door according to claim 12, wherein the first inclined member and the second inclined member are connected to each other.

14. The door according to claim 13, wherein the second inclined member comprises an exposure surface approximately flat and exposed frontward to show an advertisement.

15. The door according to claim 13, wherein a first end of the first inclined member and a first end of the second inclined member are connected to each other,
wherein the pulling knob further comprises a first coupling member which couples a second end of the first inclined member with the door; and a second coupling member which couples a second end of the second inclined member with the door.

16. The door according to claim 12, wherein the pulling knob further comprises an opposite member facing the door and one of the first inclined member and the second inclined member.

17. The door according to claim 12, further comprising a pushing knob comprising a base surface mounted to a door surface of the door, and a pad surface formed at an opposite side of the base surface and inclined to gradually get away from the surface of the door body as going in a downward direction.

18. The door according to claim 17, wherein the pulling knob comprises at least one of a first coupling member coupling the first inclined member with the door body and a second coupling member coupling the second inclined member with the door body, and
the first coupling member or the second coupling member is coupled to the pulsing knob with the door body therebetween.

19. The door according to claim 17, further comprising a depressed portion corresponding to a hand shape of a human body in the surface of the pushing knob.

20. The door according to claim 19, wherein the depressed portion has a depth gradually decreased as going in a downward direction of the door body.
